(19) United States
(12) Patent Application Publication
(10) Pub. No.: US 2020/0316831 A1
(43) Pub. Date: Oct. 8, 2020

(54) Method for manufacturing a plastic stemmed glass

(71) Applicant: JP GROSFILLEY, Martignat (FR)

(72) Inventor: Philippe GAUDIN, Groissiat (FR)

(73) Assignee: JP GROSFILLEY, Martignat (FR)

(21) Appl. No.: 16/837,619

(22) Filed: Apr. 1, 2020

(30) Foreign Application Priority Data
Apr. 2, 2019 (FR) 19/03517

(51) Int. Cl. B29C 45/14; A47G 19/22

(52) U.S. Cl. CPC B29C 45/14434; B29K 2021/003; A47G 19/2205

(57) ABSTRACT

A method for manufacturing a glass with a stem or with a base made of a plastic material, the glass including a receiving portion mounted over a base or over a stem, the method being implemented by a rotary tooling comprising a plurality of workstations and at least one mold wherein the method includes the following steps: a) forming of the receiving portion of the glass on at least one first workstation called injection station; b) overmolding of the stem or of the base over the receiving portion, in order to form a glass with a stem or with a base, the overmolding being carried out on at least one other workstation called overmolding station; c) ejection of the glass thus formed on the overmolding station or on another workstation called ejection station.

### TECHNICAL FIELD OF THE INVENTION

The invention concerns the technical field of plastic molding. More particularly, the invention relates to the manufacture of plastic glasses with a stem or base.

### TECHNOLOGICAL BACKGROUND OF THE INVENTION

In general, plastic glasses with stems or with bases are made by blow-molding injection. However, because of the large thickness of the rod of the stem, larger than 5 millimeters, this technique has many drawbacks.

Indeed, during the injection, bubbles may appear during the injection of transparent parts, which is visually very unpleasant. Furthermore, with this technique, it is difficult to control the surface conditions because of glazings visible at the surface. Moreover, the geometry and the dimensions of the glass and in particular of the receiving portion, for example shaped as a flask, are hardly controllable because of the considerable shrinkage of the molded material. In addition, it is compulsory to mold the receiving portion of the glass as half-shells, which implies a vertical mating plane which is visible, aesthetically unpleasant and troublesome for pad-printing. Furthermore, the cooling time of the injected material is considerable because of the large thickness of the stem or of the base, which also affects the molding cost.

There is known from the document FR2956610 A11 a method for injection/blow-molding on a standard press. However, if a stemmed glass is manufactured, and if the base or the stem of the glass has a thickness larger than 5 millimeters and is molded at the same time as the preform of the receiving portion, it is necessary to have a long cooling time in order to enable demolding thereof. Yet, this is not compatible with the necessity for blow-molding the preform of the receiving portion in proper conditions.

### OBJECT OF THE INVENTION

The invention aims at overcoming all or part of the aforementioned drawbacks and in particular at enabling the making of glasses with a stem or with a base in a simple, rapid manner and without any visual defect over the receiving portion of the glass.

In the present invention, the upper portion of the glass mounted over the stem or the base and shaped so as to contain a liquid is called the «receiving portion». The receiving portion may have a flared, trunconical or conical shape, or a flask-like shape, for example.

To this end, an object of the invention is a method for manufacturing a glass with a stem or with a base made of a plastic material, the glass comprising a receiving portion mounted over a base or over a stem, the method being implemented by a rotary tooling comprising a plurality of workstations and at least one mold characterized in that the method comprises the following steps:

a) Forming of the receiving portion of the glass on at least one first workstation called injection station,

b) Overmolding of the stem or of the base over the receiving portion, in order to form a glass with a stem or with a base, the overmolding being carried out on at least one other workstation called overmolding station,

c) Ejection of the glass thus formed on the overmolding station or on another workstation called ejection station.

Thanks to this method, the cycle time is optimized, in particular by the fact that the receiving portion is made independently of the stem, which allows splitting the method while enabling the making of several parts at the same time. It is possible to make the receiving portion in a color that is different from the stem or the base to the extent that these two elements are made separately. In addition, the vertical mating plane on the receiving portion no longer exists. Furthermore, this method allows for freedom in the design of the stem or of the base. Thus, complex parts, such as a glass provided with a stem having a much larger thickness than a bowl are made on the same press in a simple, rapid and economical manner, while adapting specific injection conditions for each injection of the bowl and of the stem. The material, geometry and surface condition qualities are preserved for the entire container, a pleasant appearance is ensured.

According to a feature of the invention, the step (a) of forming the receiving portion is an injection step on the injection station.

According to a feature of the invention, the step (a) of forming the receiving portion comprises the following substeps:

a.1) injection of a preform of the receiving portion on the injection station,

a.2) blow-molding of the preform injected at substep (a.1) on another workstation called blow-molding station.

According to a feature of the invention, the preform of the receiving portion made at substep (a.1) may comprise a sprue shaped so as to be engaged with the overmolding of the stem or of the base.

According to a feature of the invention, the overmolding step (b) is carried out in one single layer on the overmolding station.

According to a feature of the invention, the overmolding step (b) is carried out in a plurality of layers, at least one layer being made on at least one overmolding station and at least one second layer being made on another workstation called second layer overmolding station. Advantageously, there may be as many overmolding stations as layers to form the stem or the base of the glass.

According to a feature of the invention, the ejection step (c) is carried out with the mold open or with the mold closed.

According to a feature of the invention, the material used to form the receiving portion and/or the stem is a plastic material such as poly(methyl methacrylate), the Tritan® plastic, the styrene-acrylonitrile copolymer, acrylonitrile butadiene styrene, etc.

According to this method, optimal injection conditions are applied for the injection of the receiving portion and the injection of the stem or the base because these are injected with different injection screws and on different stations.

According to a feature of the invention, the manufacturing method according to the invention is carried out on a standard press, which allows keeping a conventional and inexpensive tooling.

According to a feature of the invention, the method comprises an additional step (d) of overmolding an elastomer material or another material over the stem or the base of the glass, said step (d) being carried out on another workstation, different from the injection, ejection and overmolding stations.

Another object of the invention is a plastic glass fitted with a stem or with a base over which a receiving portion is positioned, said glass being obtained by the manufacturing method according to the invention. Advantageously, the glass according to the invention is free of any vertical mating plane at the level of the receiving portion.

According to a feature of the invention, the glass comprises a stem formed by a rod and a base, the stem being positioned over the bottom of the receiving portion of the glass.

According to a feature of the invention, the glass comprises a base positioned below the bottom of the receiving portion of the glass.

According to a feature of the invention, at least one portion of the stem or of the base is coated with an elastomeric material.

According to a feature of the invention, the receiving portion is a flask or a flared cylindrical shape.

### BRIEF DESCRIPTION OF THE FIGURES

The invention will be better understood, thanks to the description hereinafter, which relates to embodiments according to the present invention, provided as non-limiting examples and explained with reference to the appended schematic figures. The appended schematic figures are listed hereinbelow:

FIG. 1 is a schematic view of a tooling with two workstations which may be used for the manufacturing method according to the invention according to a first or a second embodiment,

FIG. 2 is a schematic view of a tooling with three workstations which may be used for the manufacturing method according to the invention according to a third embodiment,

FIG. 3 is a schematic view of a tooling with three workstations which may be used for the manufacturing method according to the invention according to a third embodiment,

FIG. 4 is a longitudinal sectional view of a stemmed glass according to the invention made according to a first embodiment,

FIG. 5 is a longitudinal sectional view of a stemmed glass according to the invention made according to a second embodiment,

FIG. 6 is a longitudinal sectional view of a stemmed glass according to the invention made according to a third embodiment,

FIG. 7 is a longitudinal sectional view of a stemmed glass according to the invention made according to a fourth embodiment,

FIG. 8 is a longitudinal sectional view of a stemmed glass according to the invention made according to a first variant of the first embodiment,

FIG. 9 is a longitudinal sectional view of a glass with a base according to the invention made according to a second variant of the first embodiment,

FIG. 10 is a longitudinal sectional view of a stemmed glass according to the invention made according to a variant of the second embodiment,

FIG. 11 is a longitudinal sectional view of a stemmed glass according to the invention made according to a variant of the fourth embodiment,

FIG. 12 is a longitudinal sectional view of a stemmed glass according to the invention made according to a first variant of the third embodiment,

FIG. 13 is a longitudinal sectional view of a stemmed glass according to the invention made according to a second variant of the third embodiment.

### DETAILED DESCRIPTION

The glass 1 according to the invention features an axial symmetry according to a longitudinal axis A. The glass 1 comprises a receiving portion 2 and a stem 4 or a base 3 positioned below the receiving portion 2. The glass according to the invention is made of at least one plastic material.

Advantageously, and regardless of the embodiment, the stem 4 or the base 3 comprises an upper collar 10 ensuring adhesion of the stem 4 or of the base 3 below the receiving portion 2. Furthermore, regardless of the embodiment, the stem 4 comprises a rod 6 and a preferably circular base ensuring stability of the glass 1.

Advantageously, the receiving portion 2 includes at the upper portion a substantially cylindrical contour 12, having both inside and outside a shaped which may be slightly conical so as to form draft angles.

Regardless of the embodiment, the tooling 100 comprises at least one glass mold and at least two workstations: an injection station 101 and an overmolding station 103.

According to the first embodiment and the second embodiment and their respective variants, the tooling 100 comprises an ejection station 105.

According to the third embodiment and the second embodiment and their respective variants, the tooling 100 comprises a second layer overmolding station 104.

In all variants and regardless of the embodiment, the tooling 100 comprises a blow-molding station.

According to the invention, the tooling is rotary, the mold passing from one workstation to another by following a rotation.

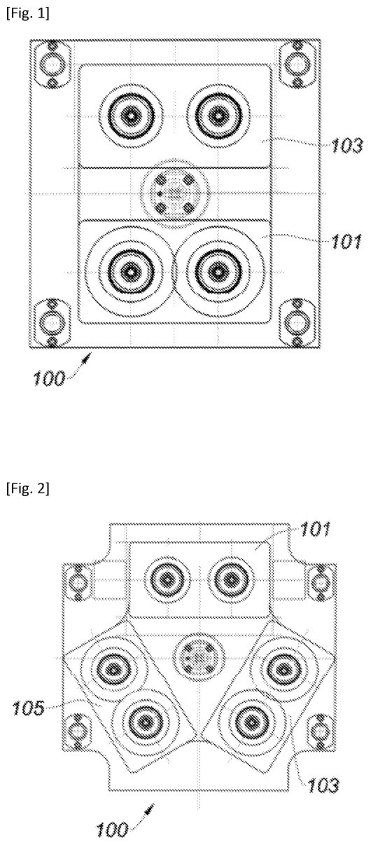

According to a first embodiment of the glass according to the invention and according to the manufacturing method of the invention, the receiving portion 2 of the glass 1 is injected on the injection station 101. Then, the stem 4 or the base 3 is overmolded over the bottom of the receiving portion 2 thus formed on the overmolding station 103. Finally, the glass 1 is ejected with the mold closed on the overmolding station 103 at the level of which the overmolding has been carried out or on the ejection station 105. The first embodiment is illustrated in FIG. 4 and the tooling used for this first embodiment is illustrated in FIGS. 1 and 2.

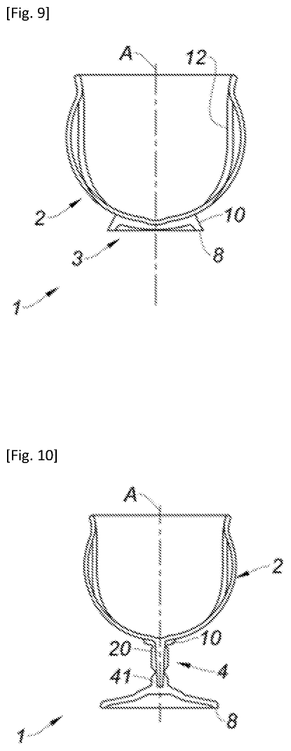

Alternatively to the first embodiment according to FIGS. 8 and 9, instead of an injection, an injection of a preform of the receiving portion on the injection station 101 and a blow-molding of said preform on the blow-molding station (not represented) are carried out.

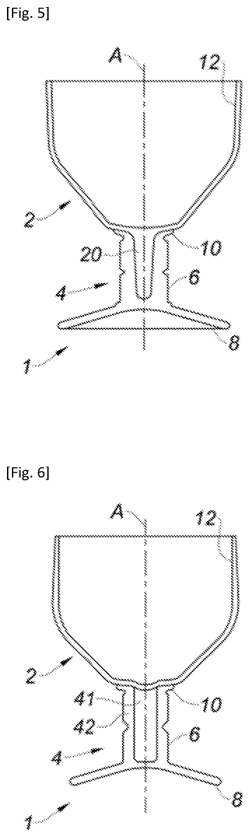

According to a second embodiment of the glass 1 according to the invention and according to the manufacturing method of the invention, the receiving portion 2 of the glass 1 is injected on the injection station 101, the injected receiving portion 2 comprises a longitudinal sprue 20 extending radially outwards from the receiving portion 2 from the bottom of the receiving portion 2, as illustrated in FIG. 5. Then, the stem 4 is overmolded over the sprue 20 on the overmolding station 103. Finally, the glass 1 is ejected with the mold closed on the overmolding station 103 at the level of which the overmolding has been carried out or on the ejection station 105. The second embodiment is illustrated in FIG. 5 and the tooling used for this second embodiment is illustrated in FIGS. 1 and 2.

Alternatively to the second embodiment according to FIG. 10, instead of an injection, an injection of a preform of the receiving portion on the injection station 101 and a blow-molding of said preform on the blow-molding station (not represented) are carried out.

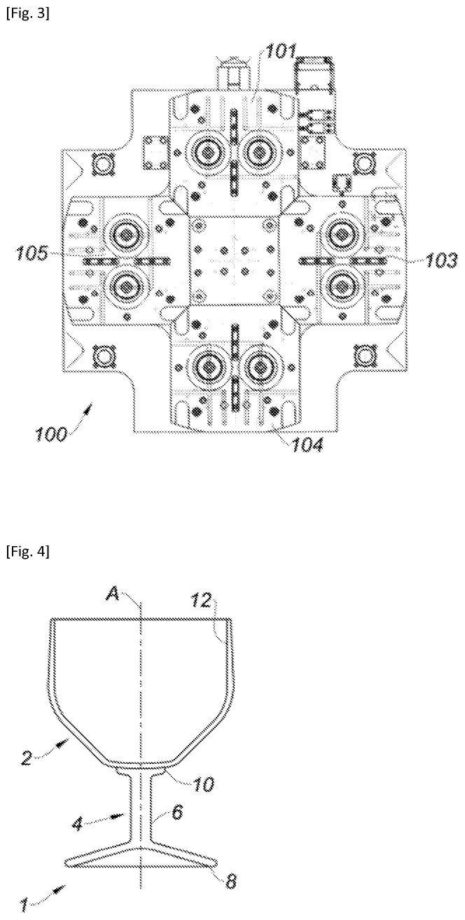

According to a third embodiment of the glass 1 according to the invention and according to the manufacturing method of the invention, the receiving portion 2 of the glass 1 is injected on the injection station 101. Then, a first plastic material layer 41 is overmolded so as to form a stem blank 4 on the overmolding station 103. Afterwards, a second plastic material layer 42 is overmolded so as to form the stem 4 or the base 3, the second overmolding being carried out on the first overmolding forming the stem blank. The overmolding of the second layer 42 is carried out on the second layer overmolding station 104. Finally, the glass 1 is ejected with the mold closed on the second layer overmolding station 104 at the level of which the overmolding of the second layer 42 has been carried out or on the ejection station 105. The third embodiment is illustrated in FIG. 6 and the tooling used for this third embodiment is illustrated in FIGS. 2 and 3.

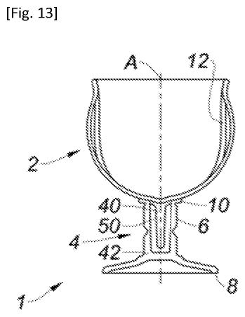

Alternatively to the third embodiment according to FIG. 12, instead of an injection, an injection of a preform of the receiving portion on the injection station 101 and a blow-molding of said preform on the blow-molding station (not represented) are carried out. In a second variant, it is also possible to add a third material layer 43 to finish the stem 4 as illustrated in FIG. 13. In a variant that is not represented, it is also possible to add an elastomeric material for an aesthetic of comfort purpose.

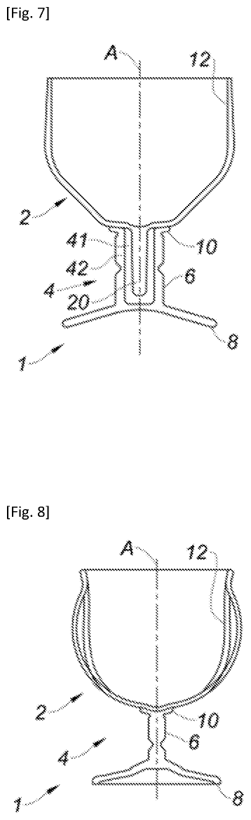

According to a fourth embodiment of the glass 1 according to the invention and according to the manufacturing method of the invention, the receiving portion 2 of the glass 1 is injected on the injection station 10, the injected receiving portion 2 comprises a sprue 20, as illustrated in FIG. 7. Then, a first plastic material layer 41 is overmolded so as to form a stem blank 4 on the overmolding station 103, the overmolding of the first layer being carried out over the sprue 20. Afterwards, a second plastic material layer is overmolded so as to form the stem 4, the second overmolding being carried out on the first overmolding forming the stem blank. The overmolding of the second layer 42 is carried out on the second layer overmolding station 104. Finally, the glass 1 is ejected with the mold closed on the second layer overmolding station 104 at the level of which the overmolding of the second layer has been carried out or on the ejection station 105. The second embodiment is illustrated in FIG. 7 and the tooling used for this fourth embodiment is illustrated in FIGS. 2 and 3.

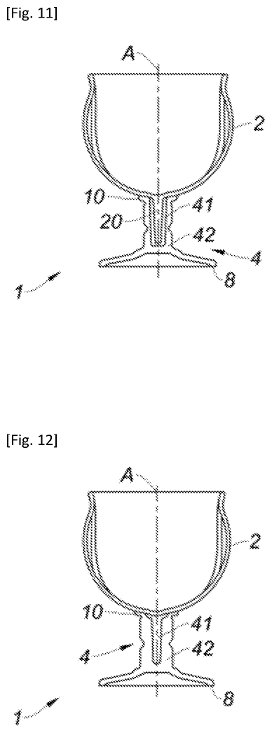

Alternatively to the fourth embodiment according to FIG. 11, instead of an injection, an injection of a preform of the receiving portion on the injection station 101 and a blow-molding of said preform on the blow-molding station (not represented) are carried out.

Finally, the method according to the invention may comprises an additional step of overmolding an elastomer material or another material over the stem or the base of the glass, said step being carried out on another workstation, different from the injection, ejection and overmolding stations.

Of course, the invention is not limited to the embodiments described and represented in the appended figures. Modifications are still possible, in particular with regards to the constitution of the various elements or by substitution with technical equivalents, yet without departing from the scope of the invention.

1. A method for manufacturing glass with a glass with a stem or with a base made of a plastic material, the glass comprising a receiving portion mounted over a base or over a stem, the method being implemented by a rotary tooling comprising a plurality of workstations and at least one mold wherein the method comprises the following steps:
a) Forming of the receiving portion of the glass on at least one first workstation called injection station,
b) Overmolding of the stem or of the base over the receiving portion, in order to form a glass with a stem or with a base, the overmolding being carried out on at least one other workstation called overmolding station,
c) Ejection of the glass thus formed on the overmolding station or on another workstation called ejection station.

2. The manufacturing method according to claim 1, wherein the step (a) of forming the receiving portion is an injection step on the injection station.

3. The manufacturing method according to claim 1, wherein the step (a) of forming the receiving portion comprises the following substeps:
a.1) injection of a preform of the receiving portion on the injection station,
a.2) blow-molding of the preform injected at substep (a.1) on another workstation called blow-molding station.

4. The manufacturing method according to claim 3, the preform of the receiving portion made at substep (a.1) may comprise a sprue shaped so as to be engaged with the overmolding of the stem or of the base.

5. The manufacturing method according to claim 1, wherein the overmolding step (b) is carried out in one single layer on the overmolding station.

6. The manufacturing method according to claim 1, wherein the overmolding step (b) is carried out in a plurality of layers, at least one layer being made on at least one overmolding station and at least one second layer being made on another workstation called second layer overmolding station.

7. The manufacturing method according to claim 1, wherein the ejection step (c) is carried out with the mold open or with the mold closed.

8. manufacturing method according to claim 1 comprising an additional step (d) of overmolding an elastomer material or another material over the stem or the base of the glass, the step (d) being carried out on another workstation, different from the injection, ejection and overmolding stations.

9. A plastic glass fitted with a stem or with a base over which a receiving portion is positioned, the glass being obtained by the manufacturing method according to claim 1.

10. The glass according to claim 9, wherein at least one portion of the stem or of the base is coated with an elastomeric material.
